(19) United States
(12) Patent Application Publication
(10) Pub. No.: US 2017/0275136 A1
(43) Pub. Date: Sep. 28, 2017

(54) EMERGENCY FALL ARRESTING SYSTEM

(71) Applicant: Home Conveyance Safety Ltd., Oro-Medonte (CA)

(72) Inventor: Andre du Preez, Oro-Medonte (CA)

(21) Appl. No.: 15/468,844

(22) Filed: Mar. 24, 2017

Related U.S. Application Data
(60) Provisional application No. 62/312,658, filed on Mar. 24, 2016.

(51) Int. Cl. B66B 5/18

(52) U.S. Cl. CPC B66B 5/18

(57) ABSTRACT

In the system, steel guides are positioned in a mine shaft; a cage is mounted to the guides for movement in the shaft in the manner of an elevator; and clamps are carried by the cage, the clamps being adapted to, when activated, grip the rails with a clamping force that increases progressively, to lock the cage to the guides.

### CROSS-REFERENCE TO RELATED APPLICATION

This application claims the benefit of U.S. Provisional Patent Application Ser. No. 62/312,658, filed Mar. 24, 2016.

### BACKGROUND OF THE INVENTION

### 1. Field of the Invention

This invention relates to the field of fall-arresting systems for mine shaft elevators.

### 2. Prior Art

Mine shaft elevators typically ride on wooden guides that extend along the shaft. A common safety feature incorporated in such elevators is a fall arresting system involving dogs which bite into the guides in slack rope conditions.

### SUMMARY OF THE INVENTION

The invention relates to a fall arresting system (FAS) that does not utilize wooden guides and dogs.

### DETAILED DESCRIPTION OF THE PREFERRED EMBODIMENTS

A detailed description of an exemplary embodiment of the invention is found in the following sections of this document entitled Technical Installation Details and Design and Operating Principles. The system provides for an advantageous combination of reliability, durability, economy and safety. Without limitation, one advantage relates to the use of the clamps which allow for clamping force to be increased progressively over a period of time, to bring any cage in free fall to which the clamps are secured to a stop in a manner that keeps deceleration forces to which the cage and its contents and occupants are exposed well below those that are associated with a dog-based FAS. The period of time can be adjusted by persons of ordinary skill in view of, inter alia, empty cage mass, number of clamps and clamp size, to ensure that the cage is brought to a stop over an appropriate period of time. Surprisingly, it has been found that this can make a measurable improvement in safety without adding greatly to costs.

Whereas a specific embodiment is herein illustrated and described, variations will of course be understood to be possible.

What is claimed is:

1. In combination, in a shaft:
steel guides positioned in the shaft;
a cage mounted to the guides for movement in the shaft in the manner of an elevator; and
clamps carried by the cage, the clamps being adapted to, when activated, grip the rails with a clamping force that increases progressively, to lock the cage to the guides.
